(19) United States
(12) Patent Application Publication
(10) Pub. No.: US 2012/0217127 A1
(43) Pub. Date: Aug. 30, 2012

(54) COIN PROCESSING APPARATUS AND METHOD

(75) Inventor: Yuji Yasui, Shizuoka-ken (JP)

(73) Assignee: TOSHIBA TEC KABUSHIKI KAISHA, Tokyo (JP)

(21) Appl. No.: 13/397,752

(22) Filed: Feb. 16, 2012

(30) Foreign Application Priority Data
Feb. 28, 2011 (JP) 2011-042671

(51) Int. Cl. G07D 1/00

(52) U.S. Cl. 194/342

(57) ABSTRACT

According to one embodiment, a coin processing apparatus, comprising: a storing section, a coin dispensing unit, a storage unit, a sensor and a drive unit. The storing section configured to house coins. The coin dispensing unit configured to dispense the coins housed in the storing section. The storage unit configured to store the coins dispensed from the coin dispensing unit. The sensor configured to detect coins in the storage unit. The drive unit configured to start driving the sensor if the coin dispensing unit starts to dispense coins, and stop driving the sensor if no dispensed coins are detected by the sensor.

### CROSS-REFERENCE TO RELATED APPLICATION

This application is based upon and claims the benefit of priority from Japanese Patent Application No. 2011-042671, filed Feb. 28, 2011, the entire contents of which are incorporated herein by reference.

### FIELD

Embodiments described herein relate generally to a coin processing apparatus and method.

### BACKGROUND

At present, the coin processing apparatus is popularized which dispenses a required number or amount of coins automatically.

For example, an automatic change machine is used in shops which are connected with a Point of Sales (POS) terminal or an Electric Cash Register (ECR), in response to an instruction from the POS terminal or ECR that the required amount of cash is dispensed, to dispense the required amount of coins to a receiving tray.

In the conventional coin processing apparatus, a sensor is provided to detect coins on the receiving tray so as to prevent the operator from forgetting to take out the coins, and an apparatus is also provided to give an alarm or inhibit the proceeding to the next action when the sensor detects coins.

### BRIEF DESCRIPTION OF THE DRAWINGS

FIG. 1 is a perspective view showing the appearance of a coin depositing and dispensing apparatus according to an embedment;

FIG. 2 is a rough front view of the main body unit of the apparatus shown in FIG. 1;

FIG. 3 is a block diagram showing the control circuit of the coin depositing and dispensing apparatus according to the embedment;

FIG. 4 is a flow chart illustrating the operations of the control unit according to the embedment.

### DETAILED DESCRIPTION

According to one embodiment, a coin processing apparatus, comprising: a storing section, a coin dispensing unit, a storage unit, a sensor and a drive unit.

The storing section configured to house coins. The coin dispensing unit configured to dispense the coins housed in the storing section. The storage unit configured to store the coins dispensed from the coin dispensing unit. The sensor configured to detect coins in the storage unit. The drive unit configured to start driving the sensor if the coin dispensing unit starts to dispense coins, and stop driving the sensor if no dispensed coins are detected by the sensor.

An embodiment is described in detail below with reference to accompanying drawings.

Further, in this embodiment, a coin depositing and dispensing apparatus is referred as an example of the coin processing apparatus. The coin depositing and dispensing apparatus is connected with a commodity sales processing apparatus, such as a POS terminal, an RCR or a self-checkout terminal by which a customer can perform a settlement process by itself, and capable of depositing coins and dispensing a required amount of coins in response to an instruction from the commodity sales processing apparatus.

[Appearance and Structure]

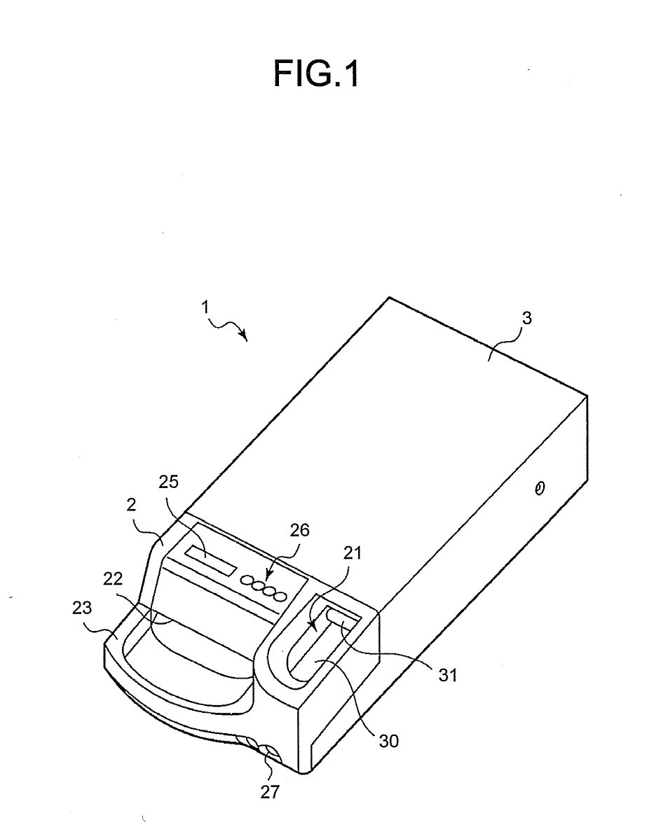

FIG. 1 is a perspective view showing the appearance of the coin depositing and dispensing apparatus 1 according to this embodiment.

The coin depositing and dispensing apparatus 1 comprises a main body unit 2 and a housing case 3 that houses the main body unit 2 such that the main body 2 can be pulled out from the front side of the case 3.

A coin slot 21, a coin dispensing port 22, a coin receiving tray 23, a display unit 25, an operation unit 26 and a power switch 27 are arranged at the front side of the main body unit 2.

The coin slot 21 is arranged at the right side of the front of the main body unit 2, with an opened upper side in a size suitable for depositing a plurality of coins at a time. The bottom surface of the coin slot 21 is constituted with a coin depositing belt 30 which conveys coins thrown into the coin depositing and dispensing apparatus 1. A separation roller 31 is arranged, at the downstream side in the conveying direction of the coin depositing belt 30, opposite to the coin depositing belt 30 at a little distance greater than the size of one coin to separate the overlapped coins conveyed by the coin depositing belt 30.

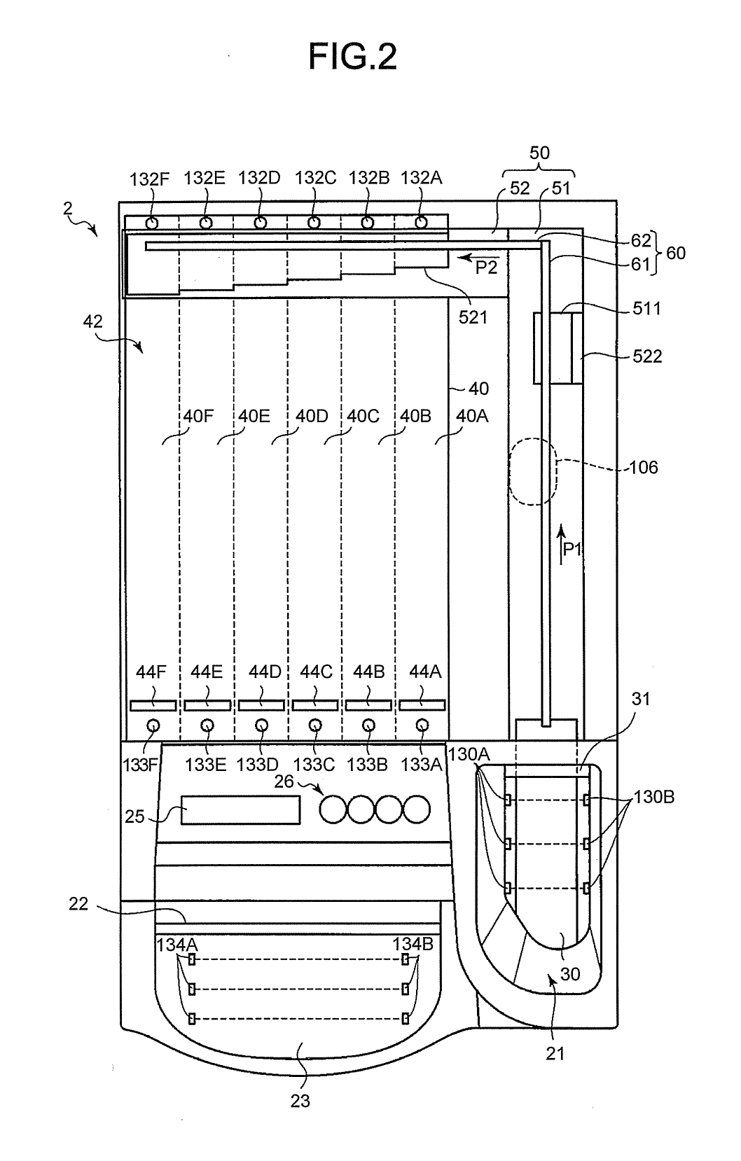

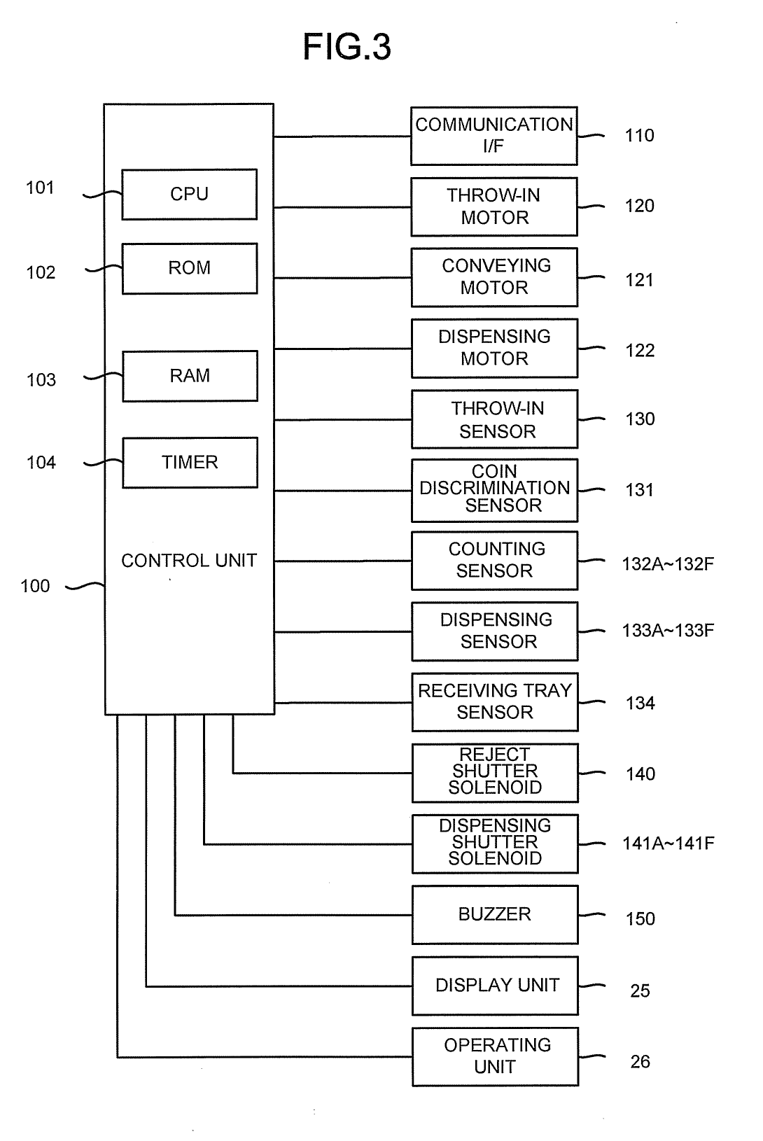

Moreover, a depositing sensor 130 (referring to FIG. 2 and FIG. 3) is arranged in the coin slot 21 to optically detect coins put into through the coin slot 21.

On the front of the main body unit 2, the coin dispensing port 22 and the coin receiving tray 23 are arranged from the center to the left side. The coins dispensed from the inside of the main body unit 2 are discharged from the coin dispensing port 22. The coin receiving tray 23 having an opened upper side is arranged around the coin dispensing port 22 to store the coins discharged from the coin dispensing port 22.

A receiving tray sensor 134 (referring to FIG. 2 and FIG. 3) is arranged in the coin receiving tray 23 to optically detect coins in the coin receiving tray 23.

The display unit 25 and an operation unit 26 are arranged above the coin dispensing port 22. The display unit 25, which is a liquid crystal display (LCD) or a vacuum fluorescent display (VFD) or the like, is used for displaying various states of the coin depositing and dispensing apparatus 1. The operation unit 26 consisting of a plurality of operation buttons is used for inputting instructions given by the user.

The power switch 27 is turned on or off to control supply of power to the coin depositing and dispensing apparatus 1.

[Internal Structure]

The internal structure of the coin depositing and dispensing apparatus 1 is described here.

FIG. 2 is a front view roughly showing the main body unit 2 pulled out from the housing case 3. A coin storing section 40, above which a coin conveying channel 50 is arranged, is arranged in the main body unit 2. Moreover, a conveying mechanism 60 and a coin discrimination sensor 106 are arranged above the coin conveying channel 50.

The coin storing section 40 is divided into denomination class storing sections 40a, 40b, 40c, 40d, 40e and 40f for storing coins of different nominal values. The denomination class storing sections 40a-40f are all connected with the coin dispensing port 22 and formed in the shape of a box with an opened top to house 1-yen coins, 50-yen coins, 5-yen coins, 100-yen coins, 10-yen coins and 500-yen coins.

A dispensing belt 42 is arranged on the bottom side of each denomination class storing section to convey the coins housed in the denomination class storing sections to the coin dispensing port 22. The dispensing belt 42 is an annular belt extended between a drive roller driven by a dispensing motor 122 (referring to FIG. 3) and a driven roller. Moreover, dispensing shutters 44a, 44b, 44c, 44d, 44e and 44f are arranged in the coin storing section 40 each of which moves towards or away from the dispensing belt 42 of a corresponding denomination class storing section 40a, 40b, 40c, 40d, 40e or 40f independently. The channel between a denomination class storing section 40a, 40b, 40c, 40d, 40e or 40f and the coin dispensing port 22 is closed when a corresponding dispensing shutter 44a, 44b, 44c, 44d, 44e or 44f moves towards the dispensing belt 42 and opened when the dispensing shutter moves back. By driving the dispensing belt 42 while driving the dispensing shutters 44a-44f to selectively close or open the channels between the denomination class storing sections 40a-40f and the coin dispensing port 22, a required number of coins are dispensed from the coin dispensing port 22 as a change.

Dispensing sensors 133a, 133b, 133c, 133d, 133e and 133f are arranged between the dispensing shutters 44a-44f and the coin dispensing port 22 to detect coins that are conveyed from respective denomination class storing sections 40a-40f and then pass by the installed location of the dispensing shutters 44a-44f.

The coin conveying channel 50 comprises a first conveying surface 51 starting with the terminal end of the coin depositing belt 30 and extending in the depth direction (P1 direction shown in FIG. 2) of the main body unit 2 and a second conveying surface 52 starting with the terminal end of the first conveying surface 51 and extending in a direction (P2 direction shown in FIG. 2) perpendicular to the P1 direction. In addition, a guiding component not shown in FIG. 2 is arranged surrounding the coin conveying channel 50 to limit the movement of the conveyed coins on the coin conveying channel 50.

The conveying mechanism 60 comprises a first conveying belt 61 for conveying coins captured by the coin depositing belt 30 in the P1 direction by pressing the obverse sides of the coins on the first conveying surface 51, and a second conveying belt 62 for conveying the coins conveyed to the terminal end of the first conveying surface 51 by the first conveying belt 61 in the P2 direction by pressing the obverse sides of the coins on the second conveying surface 52. The conveying belts 61 and 62 are annular belts extended between a driving roller driven by a dispensing motor 121 (referring to FIG. 3) and a driven roller.

The coin discrimination sensor 106 is arranged on the first conveying surface 51 to distinguish the genuineness of the coins conveyed thereon. Specifically, the coin discrimination sensor 106, which is composed of opposite excitation coils and detection coils that are spaced from each other by the first conveying surface 51, distinguishes the genuineness of coins according to a pattern showing the variation in the amplitude or phase of the induced voltage of the detection coils caused by changes in the magnetic line of force with the coins passing between the excitation coils and the detection coils.

A reject hole 511 is arranged on the first conveying surface 51. The rejection hole 511 is formed such that the right side edge of the first conveying surface 51 is cut at a downstream side in the P1 direction with respect to the coin discrimination sensor 106. A reject shutter 512 is arranged nearby the reject hole 511 to close part of the reject hole 511. When the coin discrimination sensor 106 discriminates the genuineness of coins, the reject shutter 512 is opened so that false coins distinguished can drop from the reject hole 511 into a reject box (not shown) that can be freely housed into or taken out of the main body unit 2.

Coin sorting holes 521 are arranged on the second conveying surface 52 to sort coins conveyed on the second conveying surface 52 according to the nominal values of the coins and to enable the drop of the coins from the coin conveying channel 50. Specifically, in the P2 direction, the coin sorting holes 521 are orderly formed with widths corresponding to the sizes of 1-yen coins, 50-yen coins, 5-yen coins, 100-yen coins, 10-yen coins and 500-yen coins, thereby enabling the drop of the coins conveyed to a corresponding width position by the second conveying belt 62 into a corresponding one of the denomination class storing sections 40a-40f.

Counting sensors 132a, 132b, 132c, 132d, 132e and 132f are arranged nearby the coin sorting holes 521. Each of the counting sensors 13a2-132f detects coins dropping into the denomination class storing sections 40a-40f from the respective coin sorting holes 521.

Below is description on a throw-in sensor 130 at the coin slot 21. The throw-in sensor 130 is a transmissive sensor consisting of three light-emitting components 130a and three light-receiving components 132b, wherein the three light-receiving components 130b are arranged corresponding to the three light-emitting components 130a and each outputs a light-receiving signal after receiving light from a corresponding light-emitting component 130a. Each unit of the light-emitting components 130a and the light-receiving components 130b is oppositely arranged near by the bottom surface of the coin receiving tray 23 and spaced by a coin depositing belt 30. When coins dispensed from the coin dispensing port 22 drops on a line connecting the light-emitting component 130a and the light-receiving component 130b of each unit, the light emitted from the light-emitting component 130a is interrupted, which makes the signal output from the light-receiving component 130b stop.

Below is description on the receiving tray sensor 134 provided on the coin receiving tray 23. The receiving tray sensor 134 is a transmissive sensor consisting of three light-emitting components 134a and three light-receiving components 134b, wherein the three light-receiving components 134b are arranged corresponding to the three light-emitting components 134a and each outputs a light-receiving signal after receiving light from a corresponding light-emitting component 134a. Each unit of the light-emitting components 134a and the light-receiving components 134b is oppositely arranged near by the bottom surface of the coin receiving tray 23. When coins dispensed from the coin dispensing port 22 drops on a line connecting the light-emitting component 134a and the light-receiving component 130b of each unit, the light emitted from the light-emitting component 134a is interrupted, which makes the signal output from the light-receiving component 134b stop.

[Control Circuit]

The control circuit of the coin depositing and dispensing apparatus 1 is described below.

FIG. 3 is a block diagram showing the control circuit of the coin depositing and dispensing apparatus 1. The coin depositing and dispensing apparatus 1 comprises a control unit 100 serving as a control center. The control unit 100 is connected with a communication interface (I/F) 110, a throw-in motor 120, a conveying motor 121, a dispensing motor 122, a throw-in sensor 130, a coin discrimination sensor 131, counting sensors 132a-132f, dispensing sensors 133a-133f, a receiving tray sensor 134, a reject shutter solenoid 140, dispensing shutter solenoids 141a-141f, a buzzer 150, a display unit 25 and an operation unit 26, thereby forming the control circuit of the coin depositing and dispensing apparatus 1.

The communication I/F 110 communicates with the commodity sales processing apparatus in a wired or wireless manner.

The throw-in motor 120 drives the drive roller of the coin depositing belt 30 to rotate the coin depositing belt 30. The conveying motor 121 drives the drive rollers of the first conveying belt 61 and the second conveying belt 62 to rotate the first and second conveying belts 61 and 62. The dispensing motor 122 drives the drive roller of the dispensing belt 42 to rotate the dispensing belt 42.

The reject shutter solenoid 140 opens or closes the reject shutter 512. The dispensing shutter solenoids 141a-141f enable dispensing shutters 44a-44f to move towards or away from the dispensing belt 42, respectively.

The buzzer 150 outputs buzzing sound.

The control unit 100 consists of a central processing unit (CPU) 101, a read only memory (ROM) 102, a random access memory (RAM) 103 and a timer 104.

Control programs of the coin depositing and dispensing apparatus 1 are stored in the ROM 102. The amount of balance or number of the coins in each denomination housed in the coin storing unit 40 is stored in the RAM 103. Various processing including depositing and dispensing of coins are achieved by executing the control programs stored in the ROM 102 by the CPU 101.

[Operations]

Below is description on the operations of the control unit 100.

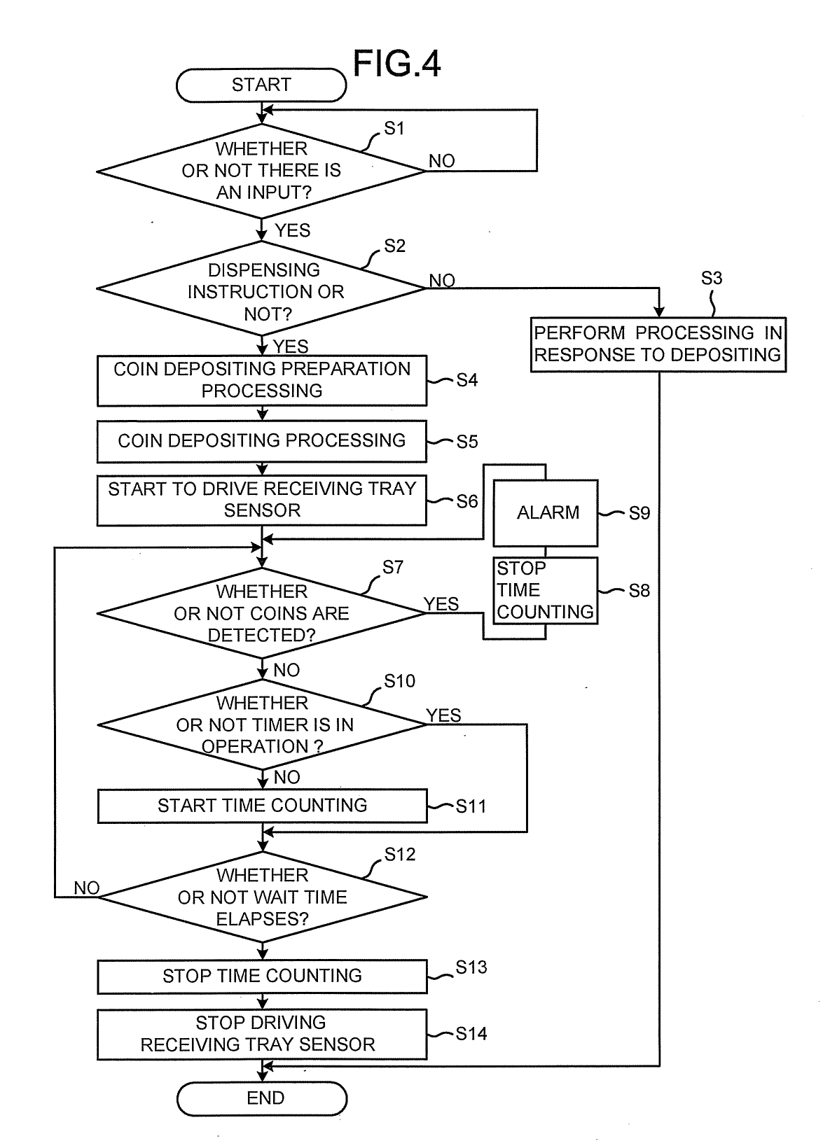

FIG. 4 is a flow chart illustrating the operations of the control unit 100.

When the coin depositing and dispensing apparatus 1 is powered on, the control unit 100 enters into an idle state to wait an input from the communication I/F 110 or the operation unit 26 while monitoring the output of the throw-in sensor 130 (Act S1). At this time, if some input is performed or a change in the output from the throw-in sensor 130 occurs (Act S1: Yes), the control unit 100 judge whether or not the input is a coin dispensing instruction (Act S2). The dispensing instruction is, for example, output by the commodity sales processing apparatus during a settlement process and received by the communication I/F 110 together with the information representing a dispensing amount, i.e., a change amount.

If it is determined that the input is not a dispensing instruction (Act S2: No), the control unit 100 performs a processing responding to the input (Act S3). For instance, the control unit 100 performs a setting processing responding to an instruction when the instruction for various settings relating to the operation of the coin depositing and dispensing apparatus 1 is input through the operation unit 26.

Moreover, the control unit 100 performs a coin depositing processing when the output from the throw-in sensor 130 is changed, that is, the signal output from any one of the light-receiving components 134b is stopped after coins are thrown into from the coin slot 21.

In the coin depositing processing, the control unit 100 drives the throw-in motor 120 and the conveying motor 121 to rotate the coin depositing belt 30 and the conveying belts 61 and 62. At this time, the coins thrown into the coin slot 21 are conveyed into the coin depositing and dispensing apparatus by the coin depositing belt 30 and, if necessary, separated from each other by the separation roller 31, and then supplied to the first conveying surface 51. The coins supplied to the first conveying surface 51 are further conveyed by the first conveying belt 61 on the first conveying surface 51 in the P1 direction.

Then, the coins pass the set position of the coin discrimination sensor 131, and if the coin discrimination sensor 131 determines that the coins are false coins, the control unit 100 drives the reject shutter solenoid 140 to change the reject shutter 512 from the closed state to the open state to make the false coins drop from the reject hole 511.

On the other hand, in the case where the coin discrimination sensor 131 determines that the coins are not false, the reject shutter 512 is maintained in the closed state, and the coins pass on the reject hole 511. The coins are further conveyed by the second conveying belt 62 on the second conveying surface 52 in the P2 direction and then respectively drop into the denomination class storing sections 40a-40f from corresponding positions of the coin sorting holes 521. The coins dropping from the coin sorting holes 521 are detected by corresponding counting sensors 132a-132f. The control unit 100 stores the detection results of the counting sensors 132a-132f in the RAM 103. If no coins are detected by the throw-in sensor 130, the control unit 100 stops the throw-in motor 120 and the conveying motor 121. Moreover, the control unit 100 calculates, with reference to the detection results of the counting sensors 132a-132f stored in the RAM 103, the amount of the coins housed in the coin storing section 40 according to the nominal values of the coins corresponding to the counting sensors 132a-132f and the coin detection times of the counting sensors 132a-132f. Moreover, the control unit 100 adds the calculated amount to the amount stored in the RAM 103 and the coin detection times of each of the counting sensors 132a-132f to the number of the coins of each nominal value stored in the RAM 103.

After completing the above-described coin depositing flow, the control unit 100 once terminates the processing shown in FIG. 4, and repeats the coin depositing flow starting with Act S1.

If it is determined that the input in Act S1 is a dispensing instruction (Act S2: Yes), the control unit 100 performs a coin dispensing preparation processing (Act S4). In the coin dispensing preparation processing, the dispensing amount shown by the information received together with the dispensing instruction is compared with the storage amount stored in the RAM 103, and if the dispensing amount is below the storage amount, then the number of the coins of each nominal value to be dispensed is determined according to the dispensing amount and the number of the coins of each nominal value stored in the RAM 103. At this time, the number of the coins of each nominal value to be dispensed is determined according to a rule that the number of the dispensed coins is minimized. In addition, if the dispensing amount is above the storage amount, then an error is informed and the processing shown in FIG. 4 is ended.

The control unit 100 performs a coin dispensing processing (Act S5) after completing the Act S4. In the coin dispensing processing, first, the control unit 100 drives the dispensing motor 122 to rotate the dispensing belt 42 and conveys the coins housed in each of the denomination class storing sections 40a-40f to the coin dispensing port 22. Then, the control unit 100 drives the dispensing shutter solenoids 141a-141f to move the dispensing shutters 44a-44f backward from the dispensing belt 42 and counts the number of the coins detected by each of the dispensing sensors 133a-133f. Moreover, the control unit 100 successively moves the ones of the dispensing shutters 44a-44f corresponding to the coins of which the detection of the number of dispensing amounts determined in the Act S4 is ended towards the dispensing belt 42. In addition, the ones of the dispensing shutters 44a-44f corresponding to the coins of each nominal value whose number of dispensing amounts is zero may not be moved from the beginning. In this way, coins of different nominal values are dispensed from the coin dispensing port 22 according to the number of dispensing coins determined in Act S4. The dispensed coins are stored in the coin receiving tray 23.

After dispensing coins through the coin dispensing processing, the control unit 100 starts to activate the receiving tray sensor 134 (Act S6), that is, makes the light-emitting components 134a give off light and monitors the output from the light-receiving components 134b. Then, the control unit 100 judges whether or not the receiving tray sensor 134 detects coins (Act S7). At this time, if there is at least one light-receiving component 134b outputting no light-receiving signal, then the control unit 100 determines that the receiving tray sensor 134 detects coins (Act S7: Yes), stops the timer 104 if the timer is in operation to reset time (Act S8), and performs an alarm processing (Act S9). In the alarm processing, the control unit 100 enables the buzzer 150 to give off buzzing sound while displaying a message that informs that coins are not taken out on the display unit 25. Moreover, a status indicating that there are residual coins is output to the commodity sales processing apparatus via the communication I/F 110. And the control unit 100 continues to perform the above-described alarm processing till no coins are detected by the receiving tray sensor 134.

Moreover, Acts S7-S9 are repeatedly executed when the receiving tray sensor 134 detects coins, that is, the proceeding to the next action is impossible. In this case, the coin dispensing responding to a coin dispensing instruction given from the commodity sales processing apparatus will be stopped even if the coin dispensing instruction is successively given.

In other words, when no coins are detected by the receiving tray sensor 134 (Act S7: No) as the coins are taken away from the coin receiving tray 23 by the operator, the control unit 100 judges whether or not the timer 104 is in operation (Act S10). If the timer 104 is stopped (Act S10: No), then the control unit 100 activates and starts the timer 104 (Act S11). If the timer 104 is in operation (Act S10: Yes) or after the timer 104 is started in Act S11, the control unit 100 judges whether or not the timer 104 finishes counting a predetermined wait time (Act S12), wherein the wait time is stored, for example, in the ROM 102 beforehand.

The control unit 100 executes Acts S7-S9 again when the timer 104 still counts the wait time (Act S12: No). On the other hand, the control unit 100 stops the action of the timer 104 and resets the time counted (Act S13) when the timer 104 finishes counting the wait time (Act S12: Yes). Moreover, the control unit 100 stops driving the receiving tray sensor 134 (Act S14).

After completing the above-described flow, the control unit 100 once finishes the processing shown in FIG. 4 and repeats the flow starting with Act S1.

As stated above, in this embodiment, the coin depositing and dispensing apparatus 1 starts to drive the receiving tray sensor 134 when coins are dispensed from the coin dispensing port 22 and stops driving the receiving tray sensor 134 when no coins are detected by the receiving tray sensor 134. In this structure, no alarm is given even goods are temporarily placed on the coin receiving tray 23 or the operator puts hands into the coin receiving tray 23 during the period until which next coins are dispensed from the coin dispensing port 22 after the coins on the coin receiving tray 23 are taken away.

Moreover, the receiving tray sensor 134 is driven when the coins, the number of which is determined in Act S4, are all dispensed. This structure can prevent that the receiving tray sensor 134 detects coins on the way to dispense and alarm is performed in one job (one processing).

Further, the receiving tray sensor 134 is continuously driven till the wait time elapses, even no coins are detected by the receiving tray sensor 134. In this structure, in the case where coins on the coin receiving tray 23 are taken away by the operator and then drop from the hands of the operator, that is, there are residual coins, the receiving tray sensor 134 can still detect the coins. Additionally, the wait time can be set to be an appropriate value taking the degree of such case (accident) described above into consideration.

Thus, in this embodiment, it is convenient to use the coin depositing and dispensing apparatus 1 as the receiving tray sensor 134 is driven at the optimal moment. As a result, by using the coin depositing and dispensing apparatus 1, various processing can be smoothly performed, especially a settlement processing that is performed by the coin depositing and dispensing apparatus 1 in combination with the commodity sales apparatus described herein.

[Modifications]

Additionally, the structure disclosed in the embodiment above may have modifications in various forms, which are specifically described below.

In the embodiment above, the coin depositing and dispensing apparatus 1 is exemplarily described which is connected with a commodity sales processing apparatus, such as a POS terminal, an RCR or a self-checkout terminal and capable of depositing coins and dispensing a required amount of coins in response to an instruction from the commodity sales processing apparatus. However, the coin-dispensing structure in the coin depositing and dispensing apparatus 1 may be applied to a dedicated coin dispensing device.

Moreover, the coin-dispensing structure can be applied to a coin dispensing device integrating a POS terminal, an ECR, a self-checkout terminal, an automatic vending machine, a ticket vending machine or an automatic teller machine (ATM).

In the embodiment above, the operations of the coin depositing and dispensing apparatus 1 are achieved by executing the control programs stored in the ROM 102 by the CPU 101. However, the present invention is not limited to the above, programs can also be downloaded from a specified network into the coin depositing and dispensing apparatus 1. Or similar functions stored in a memory medium are is also installed in the coin depositing and dispensing apparatus 1. The memory medium may be a CD-ROM and any other memory medium in any form that can be readable by the coin depositing and dispensing apparatus. Moreover, the functions achieved through a pre-installation or download can also be achieved through a cooperation with an operating system (OS) installed in the coin depositing and dispensing apparatus.

In the embodiment above, the receiving tray sensor 134 is illustrated by taking a transmissive sensor consisting of light-emitting components 134a and light-receiving components 134b as an example. However, the receiving tray sensor 134 may be replaced with other types of sensors, such as a magnetic sensor which detects coins with a magnetic field generated by magnetic coils in the coin receiving tray 23.

In the embodiment above, the receiving tray sensor 134 is driven when coins, the number of which is determined in Act S4, are all dispensed and no longer driven when the wait time elapses from the moment at which no coins are detected by the receiving tray sensor 134. Apparently, the timing for the moments at which the receiving tray sensor 134 is driven and no longer driven are not limited to those described herein. For instance, the receiving tray sensor 134 can be driven when a given wait time elapses from the moment at which coins, the number of which is determined in Act S4, are all dispensed. Moreover, the receiving tray sensor 134 may be no longer driven once no coins are detected by the receiving tray sensor 134, without waiting for the elapse of the wait time.

Although several embodiments of the present invention have been disclosed for an illustrative purpose but not for a purpose of limiting the scope of the present invention, these newly-increased embodiments can be implemented in other forms, various omissions, equivalents and variations can be devised without departing from the scope of the protection of the present invention. And it should be appreciated that these embodiments and the variations thereof are within both the scope of the present invention and the scope of the claims appended hereto and equivalents thereof.

What is claimed is:

1. A coin processing apparatus, comprising:
a storing section configured to house coins;
a coin dispensing unit configured to dispense the coins housed in the storing section;
a storage unit configured to store the coins dispensed from the coin dispensing unit;
a sensor configured to detect the coins on the storage unit; and
a drive unit configured to start driving the sensor if the coin dispensing unit starts to dispense coins, and stop driving the sensor if no dispensed coins are detected by the sensor.

2. The coin processing apparatus according to claim 1, further comprising:
a determination unit configured to determine the number of coins dispensed, wherein
the coin dispensing unit dispenses coins housed in the storing section according to the number determined by the determination unit; and
the drive unit starts to drive the sensor if the coin dispensing unit finishes dispensing the coins the number of which is determined by the determination unit.

3. The coin processing apparatus according to claim 1, wherein
the drive unit stops driving the sensor when a predetermined time elapses from the moment at which no coins are detected by the sensor.

4. The coin processing apparatus according to claim 1, further comprising:
a processing unit configured to give an alarm to the operator or a high class device that is able to communicate with the coin processing apparatus if coins are detected by the sensor.

5. The coin processing apparatus according to claim 1, further comprising:
a processing unit configured to stop the dispensing of coins from the coin dispensing unit if the sensor detects coins.

6. A method for dispensing coins from a coin processing apparatus comprising a storing unit which houses coins, a storage unit, a dispensing unit, a sensor, and a drive unit, including:
dispensing coins from the storing unit by the dispensing unit;
storing the coins dispensed by the dispensing unit on the storage unit;
detecting the coins on the storage unit;
starting activating the sensor by the drive unit if the dispensing unit starts to dispense coins; and
stopping activating the sensor if no dispensed coins are detected by the sensor.
